(19) United States
(12) Patent Application Publication
(10) Pub. No.: US 2006/0289452 A1
(43) Pub. Date: Dec. 28, 2006

(54) Reversible grill with differing tilt angles

(76) Inventor: David Lequy, Annecy-Le-Vieux (FR)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 10/559,121

(22) PCT Filed: Jun. 1, 2004
(86) PCT No.: PCT/FR04/01348

§ 371 Date: May 18, 2006

(30) Foreign Application Priority Data
Jun. 3, 2003 (FR) 03/06699

(51) Int. Cl. H05B 3/68

(52) U.S. Cl. 219/452.13

(57) ABSTRACT

The invention relates to a reversible cooking grill (1) with a heated cooking plate (2), provided with a means for heating (2), first and second cooking surfaces (3, 4), arranged on opposing faces of the means for heating, which can be selectively turned. The grill (1) further comprises rest means (6, 7) for the plate (2) to support said plate (2). The grill (1) also has a container for collection of juices and a detachable thermal reflector (9), mounted under the heating means for the plate (2) which can provide a screen between the above and any support surface (8). The first and second cooking surfaces (3, 4) each have a tilt angle arranged at an angle (32) different to that of the support surface (8) according to the chosen position of reversing and which leads towards the container for collection of juices, which is accessible between and/or below the rest means for the cooking plate (6, 7), thus permitting, for at least one cooking surface, an optimum flow and convenient recovery of cooking juices.

This invention relates in general to the field of cooking apparatuses for specific products.

More specifically, the invention relates to the field of reversible grills for food and in particular a reversible cooking grill including a heated cooking plate including:

means for heating the plate,

a first and a second cooking surface arranged on opposite surfaces of the plate heating means, capable of being selectively turned over, wherein each cooking surface constitutes, by turns, an upper work surface,

the grill also comprises means for bearing the cooking plate intended to support said plate,

the grill also comprises a receptacle for collecting cooking juices and a removable heat reflector mounted under the plate heating means and capable of acting as a screen between the latter and any support surface on which the grill is placed, regardless of the cooking surface constituting the upper work surface.

Such reversible grills have two cooking surfaces that are generally different from one another so that it is possible to adapt the cooking mode according to the foods being cooked. Thus, the first cooking surface is generally smooth, for example, for browning foods and the second cooking surface is generally ribbed, for example, for grilling meat. It has been noted that it is necessary to remove the cooking juices.

For this reason, many reversible grill manufacturers have developed a variety of solutions for removing the cooking juices.

A grill similar to the type described above, enabling the cooking juices to be removed, is, for example, described in patent document U.S. Pat. No. 6,064,042 of APPLIANCE DEVELOPMENT CORPORATION.

This document describes a reversible grill comprising a cooking plate with two cooking surfaces, wherein the cooking plate is suspended by two feet attached to two opposite edges of the cooking plate, perpendicular thereto.

One of the feet has a different height than the other enabling the cooking plate to be tilted with respect to the grill support surface. The tilt angle is identical for the two cooking surfaces, which makes it possible to remove the cooking juices from the foods, by drains located in the cooking plate, to a receptacle built into the reflector of which the surface corresponds to the cooking surfaces. As the tilt and the flow of the juice occur on the side of one of the feet and the receptacle is covered by the plate, it is particularly difficult to access it in particular in order to collect the cooking juice during cooking.

An objective of this invention is to produce a reversible grill making it possible to improve the cooking of foods on each of the cooking surfaces.

In this context, the present invention aims to propose a reversible cooking grill making it possible to optimize the flow of the cooking juices, and to easily collect said juices so as to be capable of using them to baste the foods without interrupting the cooking thereof.

To this end, the reversible grill of the invention, which is consistent with the general definition provided in the preamble above, is essentially characterized in that the first and second cooking surfaces each have a tilt at a different angle with respect to the support surface according to the selected turned-over position; wherein the tilt is directed toward the juice collection receptacle, which is accessible between and/or under the cooking plate bearing means, and can thus make it possible, at least for a cooking surface, to optimize the flow and easily collect the cooking juices.

The greater the tilt of the cooking surface, at the tilt angle, with respect to the support surface which is generally horizontal, the faster the cooking juices are removed. The tilt is therefore selected according to the chosen speed of removal of the cooking juices.

Preferably, the most heavily tilted cooking surface will be the non-smooth surface, thereby enabling this surface to be drained and the cooking on the ribbed grill to be improved. Optimally, the most heavily tilted surface will preferably be a tilt with respect to the support surface of the upper grill at 3°, while the other surface is capable of being almost parallel, if not parallel (the tilt is then considered to be zero) to the support surface.

It is possible, for example, to produce a cooking plate of which at least one of the cooking surfaces has no flange along the side capable of receiving the flow of the cooking juice.

This embodiment is advantageous because it facilitates the juice collection and plate cleaning operation.

According to one embodiment, it is possible to tilt the plate by using plate bearing means made of first and second groups of bearing elements attached to the cooking plate, wherein the first group of elements is arranged on the side of the first cooking surface and defining a first cooking plate bearing surface substantially parallel to the first cooking surface and the second group of elements is arranged on the side of the second cooking surface and defining a second cooking plate bearing surface tilted with respect to the second cooking surface.

In this embodiment, the bearing elements are arranged on the sides of the cooking plate, at least other than the side of the cooking surface which has no flange, so that the juice flows freely between these bearing elements directly into a juice receptacle.

Such bearing means directly attached to the cooking plate make it possible to perform the differential tilting or turning over of the cooking surface without necessarily using additional parts to perform this function, which is particularly economical.

For example, it is possible to produce plate bearing means using first and second supports having trapezoidal lateral surfaces substantially identical to one another, wherein the supports are symmetrically assembled at opposite ends of the cooking plate so that the trapezoidal surfaces are substantially parallel to one another and oriented so that they are perpendicular with respect to the cooking plate, wherein portions of the edges of the trapezoidal surfaces located on the side of the first cooking surface thus define said first cooking plate bearing surface and portions of the edges of the trapezoidal surfaces located on the side of the second cooking surface thus define said second cooking plate bearing surface.

The advantage of such a solution is that it makes it possible, using only supports with trapezoidal surfaces, to perform both the elevation function and the differential inclination function of the cooking plate, according to the selective turned-over position of the grill, chosen by the user.

In this embodiment, the tilt of the cooking surface is provided along a tilt axis approximately perpendicular to those defined by each lateral support. Thus, it is easier to turn over the grill because the supports can be held manually, then, by a relative pivot about the tilt axis, the grill can be turned over without requiring difficult handling. Advantageously, it is easy to perform this turn-over above the heat reflector, thus reducing the risk of burning and the risk of having the cooking juices spread onto the support surface.

In addition, this advantageous embodiment makes it possible to reduce the number of parts of such a grill and, similarly, its production cost. Likewise, the similar shapes of the supports facilitates production and storage.

In a preferred embodiment, the grill according to the invention comprises a removable foot unit suitable for receiving and supporting the bearing means of the cooking plate above the support surface, which foot unit includes the heat reflector and the receptacle for collecting the cooking juices.

According to an embodiment different from the one described above in which the supports have trapezoidal lateral surfaces, the cooking plate can be oriented by this removable foot unit, of which the bearing surface receiving the cooking plate bearing means is tilted at a first tilt angle with respect to the support surface; with the plate bearing means being made of first and second groups of bearing elements attached to the plate, the first group of bearing elements being arranged on the side of the first cooking surface and defining a first cooking plate bearing surface and the second group of bearing elements being located on the side of the second cooking surface and defining a second cooking plate bearing surface, the first and second bearing surfaces are parallel to one another and tilted with respect to the cooking surfaces at a second tilt angle.

Thus, the cooking plate, which preferably has mutually parallel cooking surfaces, and is therefore tilted with respect to its first and second bearing surfaces, which themselves, although mutually parallel, are tilted when they are placed on a foot unit, has a tilt of its cooking surfaces corresponding to the sum of the tilt angles and to their difference.

The tilt angle of the plate with respect to the grill support is therefore dependent on the cooking surface that is selected as the upper work surface.

The tilt angle of the cooking plate with respect to its bearing means is preferably identical to the tilt angle of the bearing surface of the foot unit with respect to the support surface. In this way, in one of the turned-over positions of the plate on its removable foot, the work surface of the grill is parallel to the support surface of the grill, and in the other position, the work surface of the grill is tilted with respect to the support surface of the grill at an angle twice as large as that of the two reference tilt angles.

Other features and advantages of the invention will become more clear from the description below, provided as an example that is in no way limiting, in reference to the appended drawings, in which:

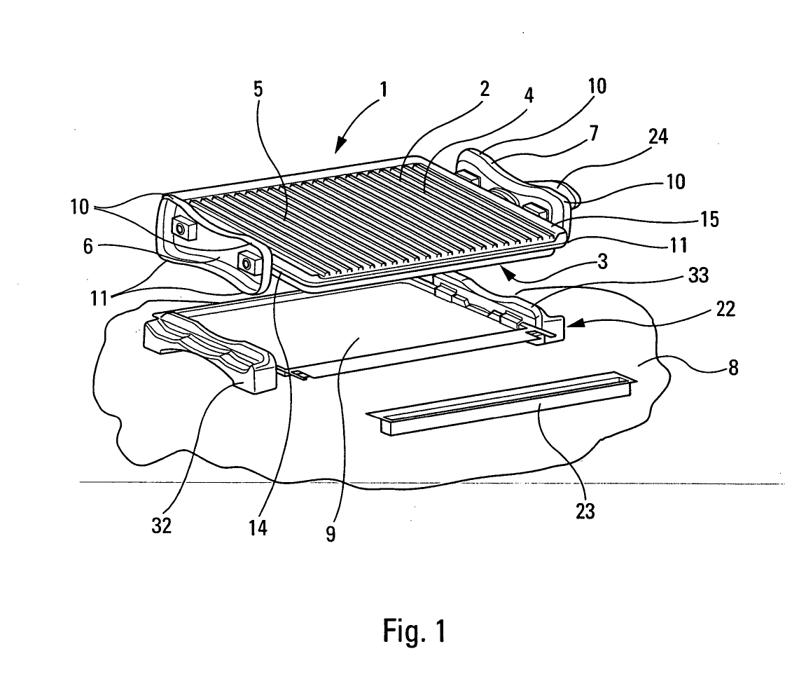

FIG. 1 shows a perspective view of an embodiment of the grill according to the invention;

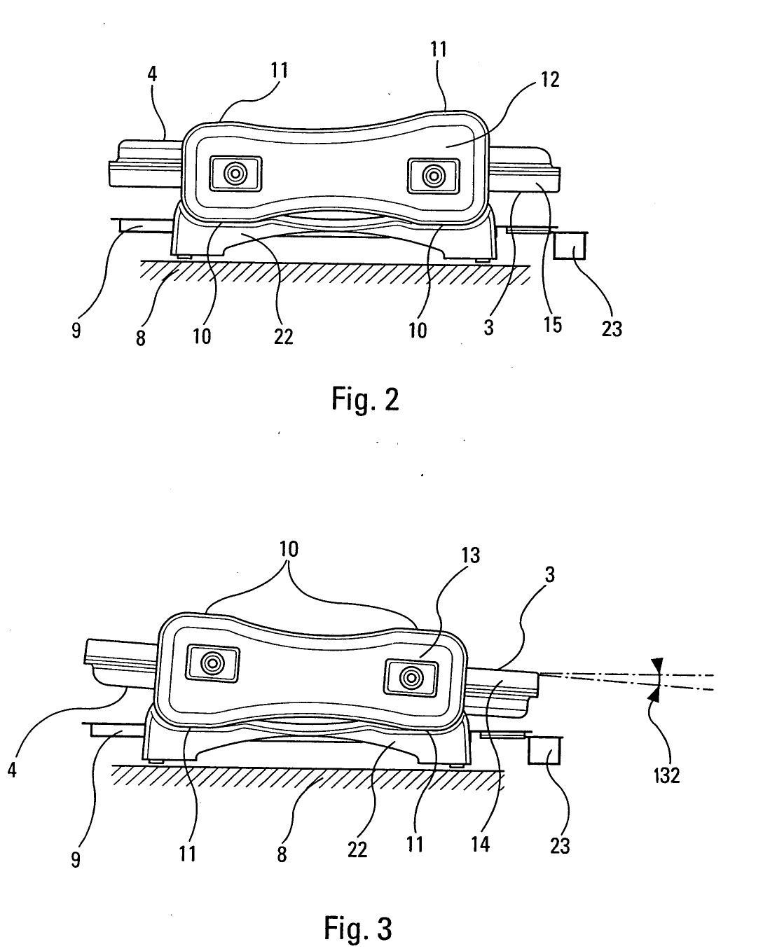

FIG. 2 shows a side view of the grill of FIG. 1, with its horizontal upper work surface;

FIG. 3 shows a side view of the grill of FIG. 1, with its tilted upper work surface;

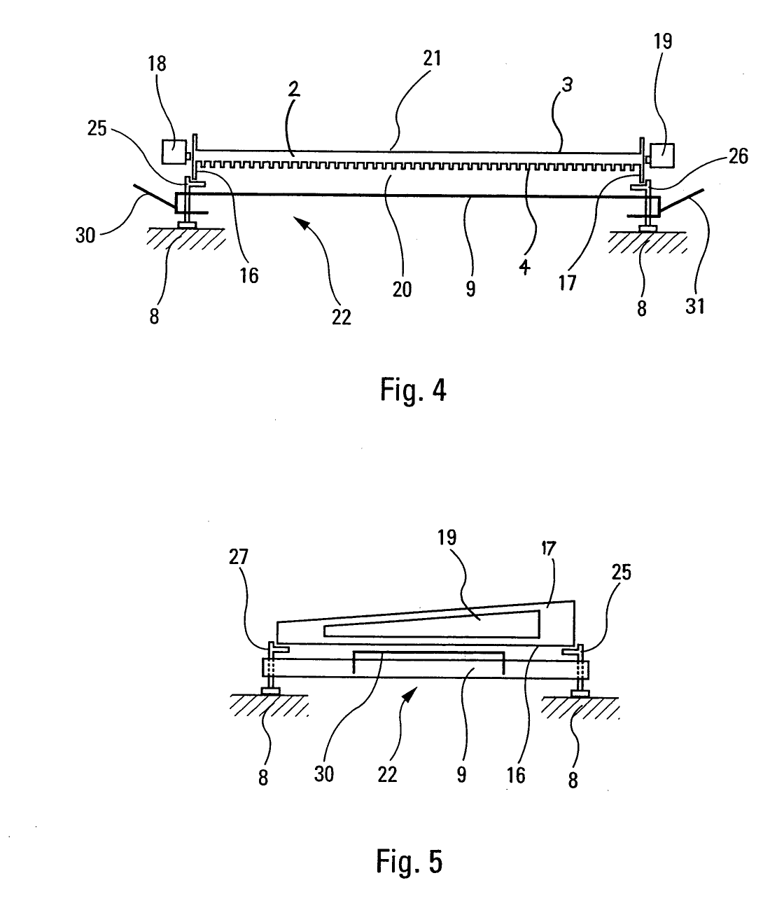

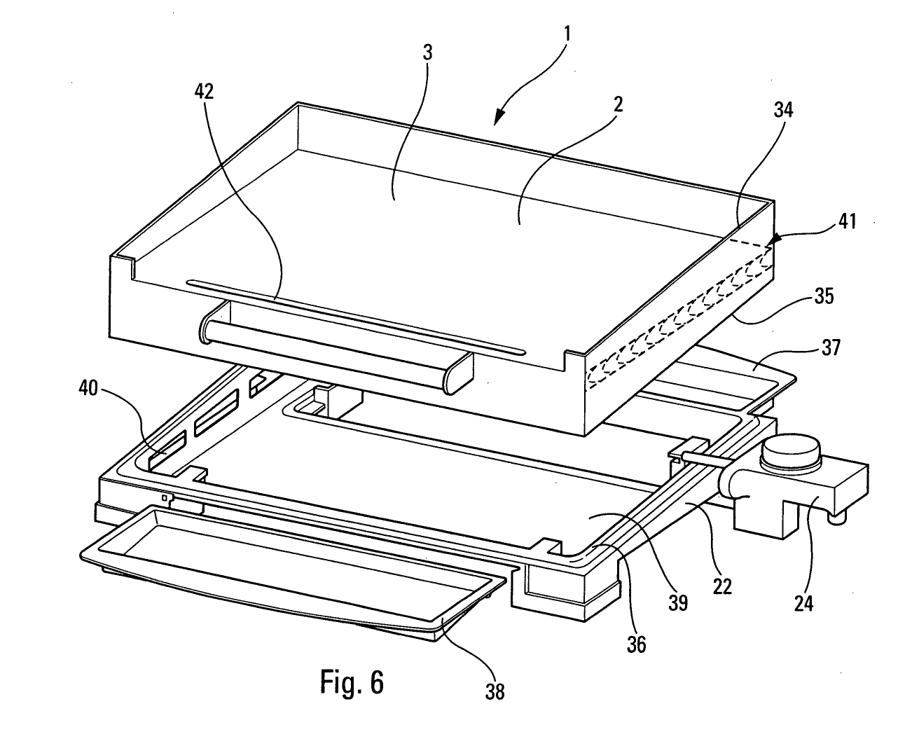

FIGS. 4 and 5 show side views of another type of grill according to the invention;

FIG. 6 shows another embodiment of the grill according to the invention;

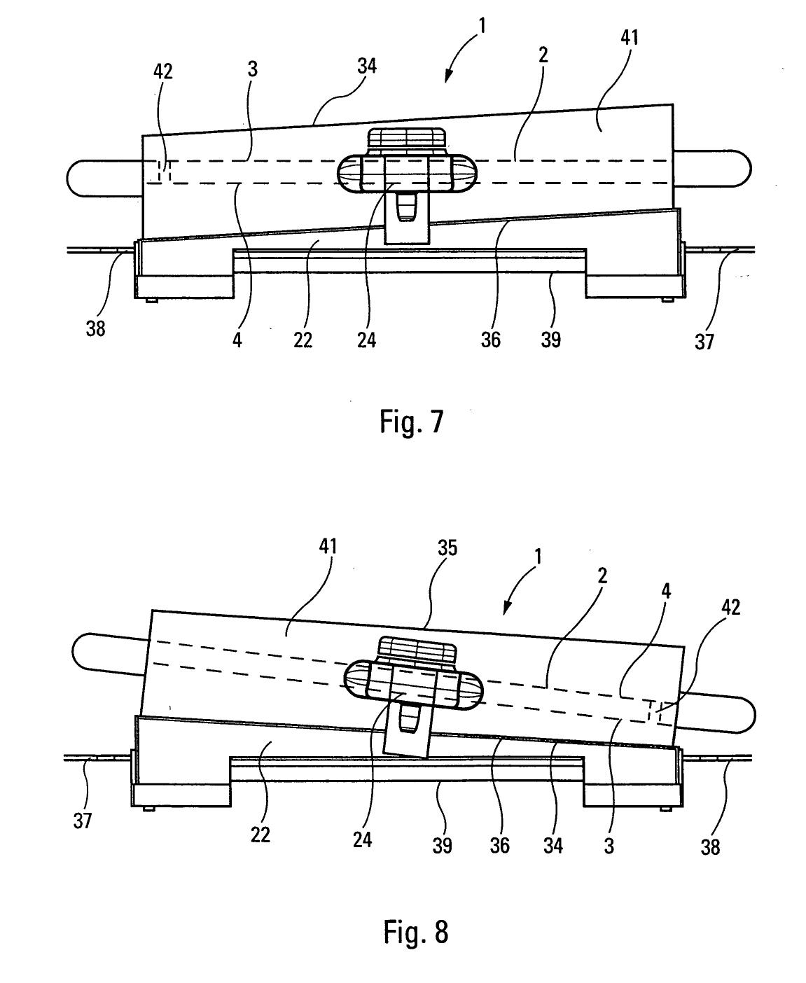

FIGS. 7 and 8 show the grill of FIG. 6 in the horizontal position and in the tilted position, respectively.

As indicated above, the invention relates to a reversible cooking grill comprising two cooking surfaces having a different tilt depending upon whether one or the other cooking surface is used as a work surface, i.e. as an upper surface.

The reversible grill 1 of FIG. 1 includes a heated cooking plate 2 including a heating means, and first and second cooking surfaces, 3 and 4, respectively, which are arranged on opposite surfaces of the plate heating means.

The grill is capable of being selectively turned over, with the cooking surface that is oriented upwards constituting an upper work surface, intended for cooking.

Bearing means 6 and 7, which are rigidly connected to the plate 2, hold it suspended with respect to the support surface 8, which is generally a table.

These bearing means are supports 6 and 7 which have trapezoidal lateral surfaces 12 and 13 that are substantially identical to one another. The first support 6 is attached to a first end 14 of the rectangular cooking plate and the second support 7 is attached to a second end 15 opposite this same plate.

The supports 6 and 7 are generally made of an electrically and thermally insulating material, such as plastic. These supports are preferably shaped so as to form gripping handles 18, 19 of the plate and are attached to the cooking plate by conventional attachment means such as screwing, snapping-on, or overmoulding.

The cooking plate can optionally be assembled with respect to the supports by any means capable of allowing for adjustment of the tilt of the plate with respect to the supports 6 and 7.

The supports 6 and 7 are assembled symmetrically so that the trapezoidal surfaces 12 and 13 are substantially mutually parallel and oriented so that they are substantially perpendicular with respect to the cooking plate 2.

Portions of the support edges of the supports 6 and 7 form a first group of bearing elements 10 and are oriented on the side of the first cooking surface 3 thus defining a first cooking plate bearing surface 2. This first bearing surface is substantially parallel to the first cooking plate 3 which is a smooth plate.

Portions of the support edges form a second group of bearing elements 11 of the feet 6 and 7 and are oriented on the side of the second cooking surface 4 thus defining a second cooking plate bearing surface 2. This second bearing surface is substantially tilted at least 3° with respect to the second cooking plate 4, which is a ribbed plate.

A removable foot unit 22 is arranged between the support surface 8 and the supports 6 and 7. The supports 6 and 7 and the removable unit 22 have complementary shapes which overlap with one another when the supports of the grill are placed on the unit. The removable foot unit is suitable for receiving and positioning the grill in its two turned-over positions.

In order to centre the supports 6 and 7 with respect to the foot unit 22, round male forms are arranged on the supports 6, 7 and correspond to female forms arranged on the removable unit 22.

The unit 22 consists of two parts forming the feet 32 and 33. The female forms corresponding to the male forms of the supports 6 and 7 are borne by the feet 32 and 33. These parts 32 and 33 are connected to one another by a heat reflector 9 and the foot unit assembly 22 is removable with respect to the cooking plate 2 and its bearing means 6 and 7.

Therefore, when the grill 1 is positioned on its removable foot unit 22, the heat reflector 9 is located between the plate heating means 2 and the support surface 8 on which the foot unit 22 rests.

This arrangement makes it possible to turn over the grill 1 so as to change work surfaces without having to move the reflector 9.

The reflector, which is generally rectangular, has a surface above that of the cooking plate. This detail makes it possible to collect, in the reflector 9, any overflow of juice that may run from the cooking surfaces of the plate 2.

A juice tray 23 can be built into or attached to the reflector 9 along the side of the surface of the cooking plate without a flange, located between the feet 32 and 33 and parallel to the tilt axis of the plate: this juice tray extends from the edge of the plate so as to directly collect the cooking juices that may flow from the surface of the plate. In FIGS. 1 to 3, the tray 23 has connection elements suitable for attaching it to the reflector 9. This tray 23 is removable so as to facilitate its cleaning and the basting of food with cooking juices without having to remove the heat reflector 9.

The heat reflector 9 can be securely mounted on the removable foot unit 22, for example when the support unit and the reflector are two separable parts. In this case, the reflector 9 can be removable from the support unit 22 so as to facilitate the cleaning operations.

The support unit 22 can alternatively be made of a single metal part functioning both as the foot and as the heat reflector.

The means for heating the cooking plate is a heating means built into the plate, including an electric resistance. The electric resistance is connected to electrical connection means 24 such as an outlet, so that the cooking plate can be unplugged simply for washing. The plate is preferably waterproof so that it can be immersed while preventing water accumulations which could be harmful in terms of electrical safety.

Electrical safety devices can be installed so as to ensure that the cooking plate 2 can be heated only when it is properly positioned and supported with respect to its foot unit 22.

The foot unit 22 preferably has, on its lower surface, support members made of a flexible material, intended to be inserted between the unit 22 and the support surface 8, so as to provide thermal, electrical and mechanical insulation between the grill 1 and the support surface 8.

FIG. 2 shows the grill 1 positioned on its foot unit 22, with the upper work surface being the first cooking surface 3. In this configuration, the bearing elements of the first group of bearing elements 10 are positioned in the corresponding recesses of the unit 22 and the first cooking surface 3 is arranged parallel to the support surface 8.

FIG. 3 shows the grill 1 positioned on its foot unit 22, with the upper work surface being the second cooking surface 4.

In this configuration, the support units 11 of the second group of bearing elements of the supports 6 and 7 are positioned in the corresponding recesses of the unit 22. The second cooking surface 4 is tilted at more than 3° with respect to the support surface 8, at an angle 32.

FIGS. 4 and 5 show another specific embodiment of the reversible cooking grill 1 in which the plate 2 bearing means 6 and 7 consist of lateral flanges 16 and 17 of the plate 2. These lateral flanges 16 and 17 are located at least along the two opposite sides surrounding one flange-free side of the plate for receiving the juice, which flange-free side is parallel to the tilt axis of the plate.

These flanges 16 and 17 have a height that is greater than the thickness of the plate 2 and are elevated above the plate, so as to provide spaces 20 and 21 between the cooking surfaces 3 and 4 of the plate 2 and the first and second cooking plate bearing surfaces 2.

In this embodiment, the removable foot unit 22 is made of four feet 25-29. Each of these feet is in contact with the support surface 8 and supports the ends of the trapezoidal flanges 16 and 17. These support feet 25-29 pass through and also support a heat reflector 9, which has a rectangular shape and a heat reflection surface above the cooking surfaces of the grill.

The reflector foot unit has handles 30 and 31 arranged on at least two of its sides. The plate 2 also has two handles 18 and 19 attached to these side flanges 16 and 17. In this case, these handles are used solely for handling the plate, and not for supporting it.

FIG. 6 shows another embodiment of a grill according to the invention having a removable one-piece foot unit 22 at a tilted bearing surface 36.

The plate bearing means 6, 7 consist of a continuous peripheral flange 41 forming two bearing surfaces 34 and 35 arranged on the opposite surfaces 3 and 4 of the plate.

This peripheral flange 41 abuts:
three sides of the plate, in which case the free side is the one provided for the flow of juice, the two lateral sides on each side of said free side are capable of having a trapezoidal shape like the flanges 16 and 17 of the embodiment of FIGS. 4 and 5 so as to provide the differing tilt of the cooking surfaces while the continuous peripheral support surface 36 of the removable foot unit 22 is horizontal and parallel to the support surface 8; or
the four sides of the plate, as shown in FIG. 6 and described in greater detail below.

The removable foot unit 22 of FIGS. 6 to 8 has a single continuous peripheral support surface 36 which defines the bearing surface 36. This peripheral surface 36 is tilted with respect to the support surface 8 and is suitable for supporting, by turns, the plate bearing surfaces 34 and 35.

The cooking plate 2 is tilted with respect to the bearing surfaces 34 and 35, which are mutually parallel.

The tilt angle of the bearing surface 36 with respect to the support surface 8 is preferably identical to the tilt angle of the plate 2 with respect to the peripheral flange 34 and 35 forming the plate bearing surfaces 6 and 7.

According to this embodiment, the plate is thus supported on its removable foot unit 22 by a single continuous peripheral surface 36, in continuous contact with one of the continuous plate bearing surfaces 34 and 35, according to the selected cooking surface. This embodiment allows for better centering and positioning as well as better stability of the plate on its foot unit 22.

In this embodiment, the heat reflection and cooking juice collection functions can be provided by a plurality of elements, including two removable elements 37, 38, which constitute juice collection trays.

These trays 37 and 38 are arranged on opposite sides of the removable unit 22 and are positioned in grooves where they are held by horizontal rails formed in the unit 22.

These removable trays 37 and 38 are intended to be placed under the cooking plate so as to enable the cooking juices to be recovered. These trays 37 and 38 are used by turns, according to the side of the grill that is selected, to collect the cooking juices.

The cooking plate is perforated by a slot 42 so as to enable the juices to flow toward the trays 37 and 38, and on the side of the cooking surface which can be positioned horizontally, the plate does not have a flange along the edge corresponding to this slot. The same applies to the other cooking surface, but on the opposite side of said slot.

The heat reflection function is also provided by a central reflection surface 39 incorporated into the removable unit 22, rigidifying the latter and suitable for being placed under the cooking plate.

To enable the heat to be evacuated, openings 40 can be provided on the sides of the support unit 22.

FIG. 7 shows the grill with the cooking plate in a position parallel to the support surface 8, i.e. with the first cooking surface 3 placed upward, and the two identical tilt angles being opposed and balancing one another.

FIG. 8 shows the grill with the cooking plate in the tilted position with respect to the support surface 8, i.e. with the second cooking surface 4 placed upward, and the two tilt angles being in the same direction and supplementing one another.

Finally, although the cooking plate 2 generally has mutually parallel cooking surfaces, it should be noted that the differential tilt of the cooking surfaces 3 and 4 can be achieved by forming a plate 2 of which the cooking surfaces 3 and 4 are not mutually parallel. This particular solution can be combined with each of the aforementioned embodiments.

1. A reversible cooking grill comprising:
a cooking plate comprising a first and a second cooking surface arranged on opposite surfaces of the cooking plate, the cooking plate capable of being selectively turned over so that each cooking surface constitutes an upper work surface when facing upward;
means for heating the cooking plate;
for bearing and supporting the cooking plate,
a receptacle for collecting cooking juices, the receptacle positioned between and/or under the bearing means;
a removable heat reflector positioned under the heating means so that the heat reflector acts as a screen between the heating means and a support surface on which the cooking plate is placed, regardless of which one of the cooking surfaces constitutes the upper work surface;
wherein when the cooking plate is placed on a support surface, the first and second cooking surfaces each have a tilt at a different angle with respect to the support surface when constituting the upper work surface; and
the receptacle positioned along an edge of the cooking plate so the upper work surface is tilted toward the receptacle, and is thus capable of collecting cooking juices that flow off the upper work surface.

2. The reversible cooking grill according to claim 1 further comprising a removable foot unit suitable for receiving and supporting the bearing means of the cooking plate with respect to the support surface, wherein the foot unit includes the heat reflector and the receptacle.

3. The reversible cooking grill according to claim 1, wherein at least one of the cooking surfaces has no flange along the edge of the cooking plate where the receptacle is positioned when that cooking surface constitutes the upper work surafce.

4. The reversible cooking grill according to claim 1, wherein the bearing means of the plate comprise first and second groups of bearing elements, wherein the first group of elements is arranged on the same side of the bearing means as the first cooking surface and defines a first cooking plate bearing surface substantially parallel to the second cooking surface, and wherein the second group of elements is arranged on the same side of the bearing means as the second cooking surface and defines a second cooking plate bearing surface having a non-zero tilt with respect to the first cooking surface.

5. The reversible cooking grill according to claim 1 further comprising a removable foot unit suitable for receiving and supporting the bearing means of the cooking plate with respect to the support surface, wherein the foot unit includes the heat reflector and the receptacle; wherein the removable foot unit is suitable for receiving and supporting the cooking plate bearing means along a support plane tilted with respect to the support surface, wherein the plate bearing means comprise first and second groups of bearing elements, the first group of bearing elements arranged on the same side of the bearing means as the first cooking surface and defining a first cooking plate bearing surface and the second group of elements arranged on the same side of the bearing means as the second cooking surface and defining a second cooking plate bearing surface, wherein the first cooking plate bearing surface is parallel with the first cooking surface and the second cooking plate bearing surface is tilted with respect to the second cooking surfaces.

6. The reversible cooking grill according to claim 4 1, wherein the bearing means of the plate comprise first and second groups of bearing elements, wherein the first group of elements is arranged on the same side of the bearing means as the first cooking surface and defines a first cooking plate bearing surface substantially parallel to the first cooking surface, and wherein the second group of elements is arranged on the same side of the bearing means as the second cooking surface and defines a second cooking plate bearing surface tilted with respect to the second cooking surface; and wherein the bearing means of the plate are first and second supports having trapezoidal surfaces substantially identical to one another, wherein the supports are symmetrically assembled at opposite ends of the cooking plate so that the trapezoidal surfaces are substantially mutually parallel to one another and perpendicular with to the cooking plate, and wherein lateral portions of the trapezoidal surfaces that are located on the same side as the first cooking surface define said first cooking plate bearing surface and lateral portions of the trapezoidal surfaces located on the same side as the second cooking surface define said second cooking plate bearing surface.

7. The reversible cooking grill according to claim 1 wherein the bearing means constitute or support gripping handles which are thermally insulated.

8. The reversible cooking grill according to claim 1 wherein the bearing means of the plate comprise plate flanges having a height greater than a thickness of the plate and which are elevated above the the first and second.

9. The reversible cooking grill according to claim 1, further comprising a removable foot unit suitable for receiving and supporting the bearing means of the cooking plate with respect to the support surface, wherein the foot unit includes the heat reflector and the receptacle, and wherein the heat reflector is securely mounted on the removable foot unit.

10. The reversible cooking grill according to claim 1 further comprising a removable foot unit suitable for receiving and supporting the bearing means of the cooking plate with respect to the support surface, wherein the foot unit includes the heat reflector and the receptacle, and wherein the heat reflector and the removable foot unit are a single part.

11. The reversible cooking grill according claim 1 wherein the heat reflector is a removable plate having a a cooking juice collection plate.

12. The reversible cooking grill according to claim 1 wherein the heat reflector also has comprises a juice tray intended for collecting the cooking juices.
